(19) United States
(12) Patent Application Publication
(10) Pub. No.: US 2005/0124186 A1
(43) Pub. Date: Jun. 9, 2005

(54) Electronic device having adapter and connection method thereof

(76) Inventors: Sea-Weng Young, Shinyuan Shiang (TW); Peter Liu, Taipei City (TW); Chao-Yong Lin, Sinjhuang City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/973,548

(22) Filed: Oct. 26, 2004

(30) Foreign Application Priority Data
Oct. 27, 2003 (TW) 92129736

(51) Int. Cl. H01R 12/00

(52) U.S. Cl. 439/71

(57) ABSTRACT

An electronic device having an adapter. The electronic device comprises a first circuit board, a first electronic element disposed on the first circuit board, a first adapter having a first surface, a second surface and a recess, and a second circuit board. The first adapter is electrically connected to the first and second circuit boards and disposed therebetween, the first electronic element is accommodated in the recess.

### BACKGROUND OF THE INVENTION

1. Field of the Invention

The present invention relates to an electronic device having an adapter, and in particular to an electronic device having an adapter accommodating electronic elements disposed on a circuit board.

2. Description of the Related Art

In surface mount technology (SMT) the leads of an electronic element are soldered to the surface on which the electronic element is positioned. Hence, no holes are required on the circuit board, enabling placement of electronic elements on both sides thereof. SMT frequently employs ball grid array (BGA) and leadless chip carrier (LCC) technologies.

In BGA technology, solder balls are placed between an electronic element (chip) and a circuit board. The circuit board is heated to melt the solder balls. Thereby, the chip is electrically connected to the circuit board. In addition to electrical connection of an electronic element and a circuit board, BGA technology can also be applied to electrical connection of two circuit boards. As shown in FIG. 1a, an array of solder balls 14 is placed between a circuit board 10 bearing an electronic element 16 and a circuit board 20. The circuit board 10 is heated to melt the solder balls 14 to electrically connect the circuit boards 10 and 20. Signals are thereby transmitted from the circuit board 10 to the circuit board 20.

As shown in FIG. 1b, the circuit board 10 further bears another electronic element 18 on the other side thereof, and the height of the electronic element 18 is greater than the diameter of the solder ball 14 making the electrical connection of the circuit board 10 and 20 impossible. Therefore, a connection structure is needed between the circuit boards 10 and 20 when both sides of the circuit board 10 bear electronic elements. (The required electrical connection therebetween is normally made possible by BGA technology.)

In addition to BGA technology, leadless chip carrier (LCC) technology can also be applied to electrical connection of the circuit boards 10 and 20. The main features of LCC technology are shown in FIG. 1c. Grooves 120 are defined on one edge of a circuit board 100 and metal pads 140 corresponding to the grooves 120 are disposed on circuit board 20. Solder is placed on the metal pad 140. When the circuit boards 100 and 20 are heated, the solder is melted and rises up along the groove 120 due to capillary force until the solder solidifies to complete the electrical connection of the circuit boards 100 and 20. When the other side of the circuit board 100 bears an electronic element 180, electrical connection is difficult to achieve with LCC technology, as shown in FIG. 1d. Thus, a connection structure is needed to electrically connect the circuit boards 100 and 20.

### SUMMARY OF THE INVENTION

Accordingly, an object of the invention is to provide an electronic device having an adapter connecting one circuit board provided with electronic elements on both sides thereof to another circuit board.

BGA technology or LCC technology can be applied to electrical connection in the invention.

The electronic device of the invention comprises a first circuit board, a first electronic element disposed on the first circuit board, a first adapter having a first surface, a second surface and a recess, and a second circuit board, wherein the first adapter is electrically connected to the first and second circuit boards and disposed therebetween, the first electronic element is accommodated by the recess.

In BGA technology, the electronic device further comprises a plurality of first solder balls disposed on the first surface and electrically connected to the first circuit board, and a plurality of second solder balls disposed on the second surface and electrically connected to the second circuit board.

In LCC technology, a plurality of first grooves are defined on the periphery of the first circuit board and longitudinally extends perpendicular to the first and second circuit boards, and a plurality of second grooves corresponding to the first grooves are defined on the periphery of the first adapter and longitudinally extends perpendicular to the first and second circuit boards.

In another aspect, BGA and LCC technology can be combined. Thus, a plurality of first solder balls are disposed on the first surface and electrically connected to the first circuit board, and a plurality of third grooves are defined on peripheral of the first adapter and longitudinally extend perpendicular to the first and second circuit boards.

The first adapter may use metal connectors to electrically connect the first and second circuit boards rather than BGA or LCC technology, wherein the first adapter further has a plurality of connectors comprising a first contacting portion, a second contacting portion and a connecting portion. The connecting portion is embedded in the first adapter, the first contacting portion and the second contact portion are protruding over the first adapter to contact the first surface and the second surface respectively. The first contacting portion, the second contacting portion and the connecting portion can be integrally formed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein;

FIG. 1a is a schematic view showing BGA technology applied to electrical connection of circuit boards as referenced in the Related Art;

FIG. 1b is a schematic view showing BC-A technology inapplicable to a circuit board with electronic elements on both sides;

FIG. 1c is a schematic view showing LCC technology applied to electrical connection of circuit boards as referenced in the Related Art;

FIG. 1d is a schematic view showing LCC technology inapplicable to a circuit board with electronic elements on both sides;

FIG. 2a is a schematic view of the first embodiment of the invention;

FIG. 2b is a front view of the first embodiment of the invention;

FIG. 2c is a top view of the first embodiment of the invention;

FIG. 3a is a schematic view of the second embodiment of the invention;

FIG. 3b is a front view of the second embodiment of the invention;

FIG. 3c is a top view of the second embodiment of the invention;

FIG. 4a is a schematic view of the third embodiment of the invention;

FIG. 4b is a front view of the third embodiment of the invention;

FIG. 4c is a top view of the third embodiment of the invention;

FIG. 5 is a schematic view of the fourth embodiment of the invention;

FIG. 6a is a schematic view of the fifth embodiment of the invention;

FIG. 6b is a perspective view of the fifth embodiment of the invention; and

FIG. 6c is cross section along A-A line of FIG. 6b.

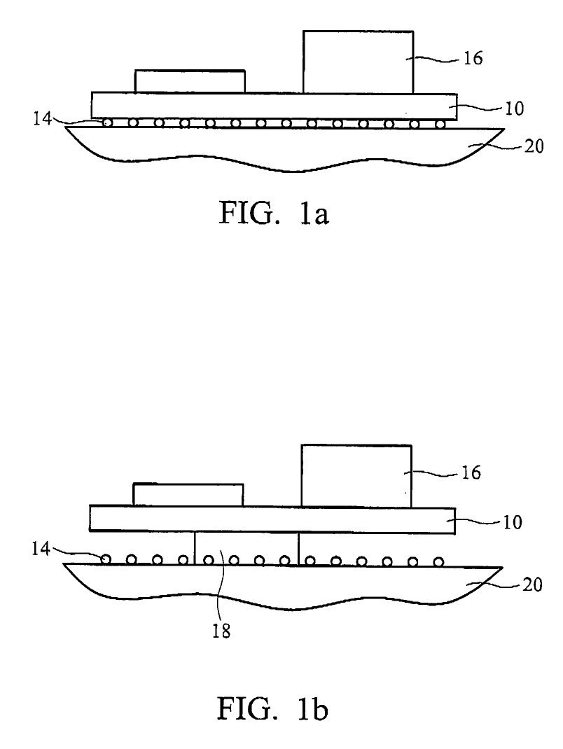

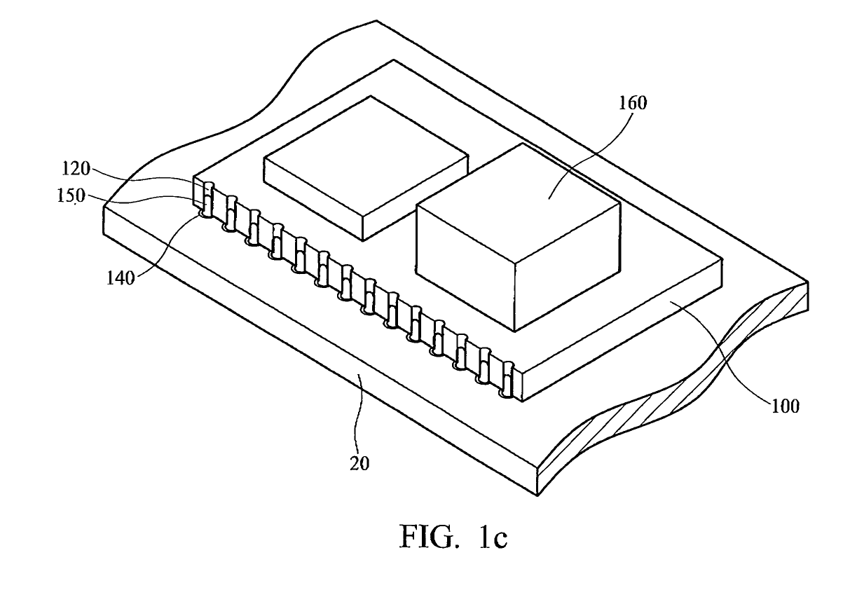

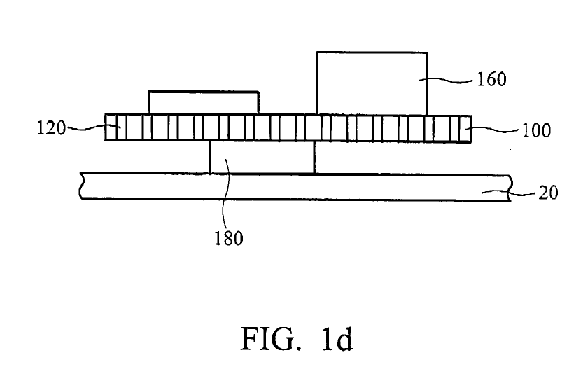

### DETAILED DESCRIPTION OF THE INVENTION

### First Embodiment

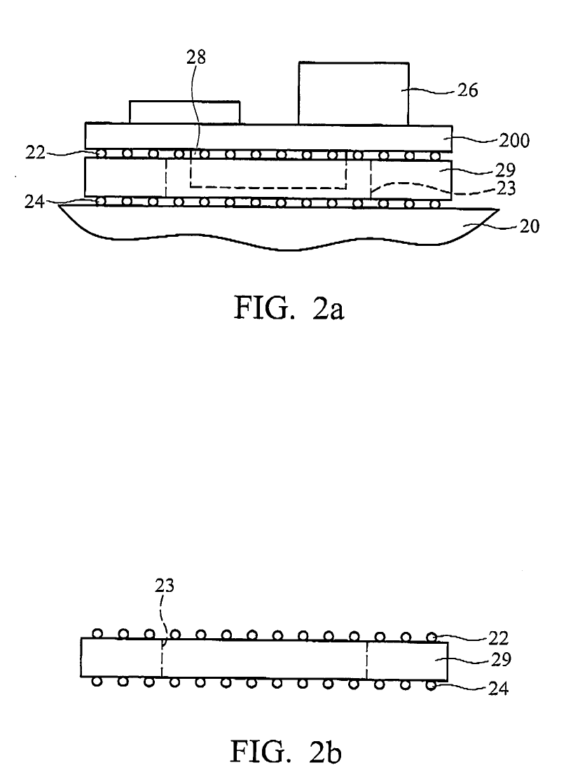

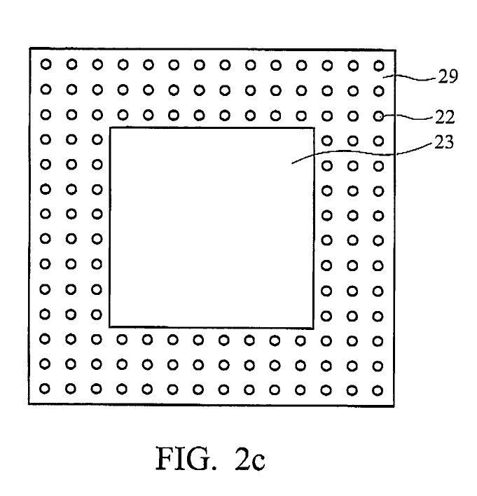

As shown in FIG. 2a, a first circuit board 200 bears an electronic element 26 on one side thereof and another electronic element 28 on the other side thereof. The first circuit board 200 is electrically connected to a second circuit board 20 via an adapter 29, and the electronic element 28 is accommodated in a recess 23 of the adapter 29.

As shown in FIGS. 2b & 2c, BGA technology is applied. A plurality of solder balls 22 are disposed on one surface of the adapter 29 and a plurality of solder balls 24 are disposed on the other surface of the adapter 29. Upon assembly, the solder balls 22 contact the first circuit board 200 and the solder balls 24 contact the second circuit board 20. The solder balls 22, 24 are melted to complete the electrical connection of the first circuit board 200, the adapter 29 and the second circuit board 20.

### Second Embodiment

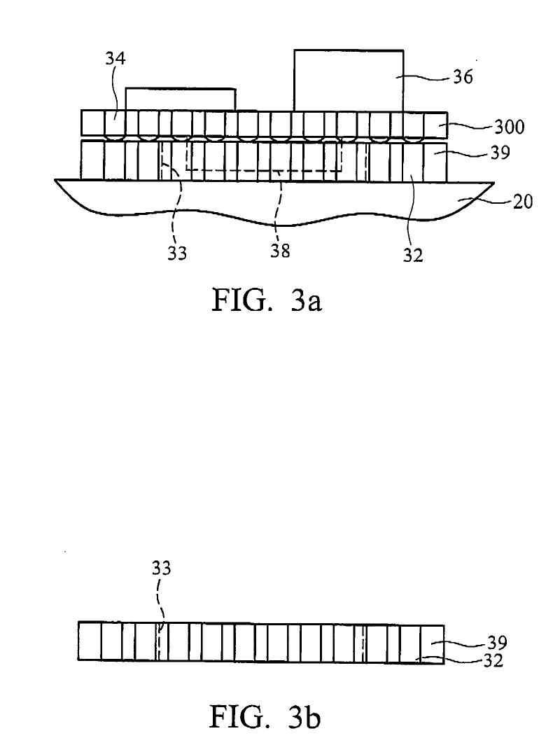

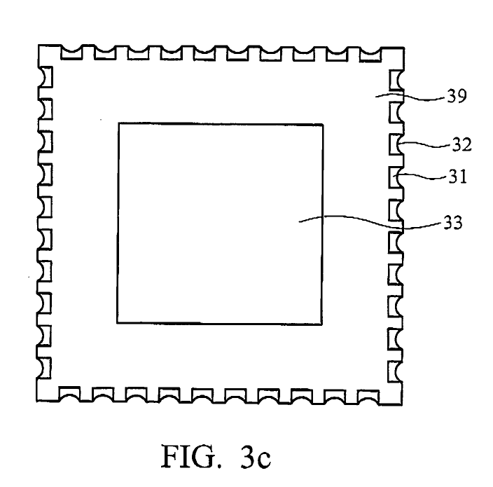

As shown FIG. 3a, an electronic element 36 is disposed on one side of a first circuit board 300 and an electronic element 38 is disposed on the other side thereof. The first circuit board 300 is electrically connected to a second circuit board 20 via an adapter 39, and the electronic element 38 is accommodated in a recess 33 of the adapter 39.

LCC technology is applied in this embodiment as shown in FIGS. 3b & 3c. A plurality of grooves 32 are defined on the periphery of the adapter 39 and a plurality of metal pads 34 corresponding to the grooves 32 are disposed on the first circuit board 300. Upon assembly, solder is placed on the metal pads 34 and heated to melt. The melted solder rises up along the grooves 32 due to capillary force until the solder solidifies to complete the electrical connection of the is circuit board 300 and the adapter 39. The electrical connection of the adapter 39 and the second circuit board 20 is completed with the same method. Solder is placed on metal pads (not shown) of the second circuit board 20, corresponding to the grooves 32 and heated to melt. The melted solder rises up along the grooves 32 until the solder solidifies to complete the electrical connection.

### Third Embodiment

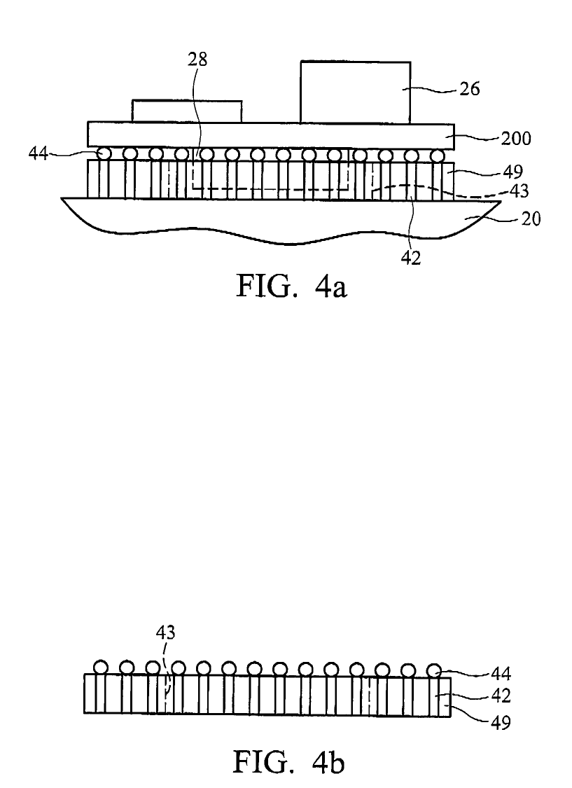

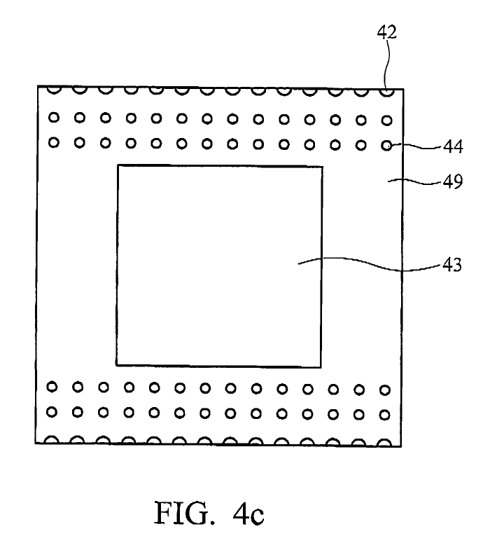

In this embodiment, BGA technology and LCC technology are combined. As shown in FIG. 4a, a first circuit board 200 bearing electronic elements 26 and 28 is electrically connected to the second circuit board 20 via an adapter 49 wherein the electronic element 28 is accommodated in a recess 43 of the adapter 49.

As shown FIGS. 4b & 4c, a plurality of grooves 42 are defined on periphery of the adapter 49, and a plurality of solder balls 44 are disposed on the adapter 49 and contacts the first circuit board 200. Thereby, BGA technology is applied to the connection of the first circuit board 200 and the adapter 49 as described in the first embodiment, and LCC technology is applied to the connection of the adapter 49 and the second circuit board 20 as described in the second embodiment.

### Fourth Embodiment

The first circuit board 200 bears electronic elements 26 & 28 on both sides thereof. If an electronic element 52 is disposed on the second circuit board 20 and the first circuit board 200 must be connected to the second circuit board 20 at the position of the electronic element 52, a connection structure having two adapters is needed.

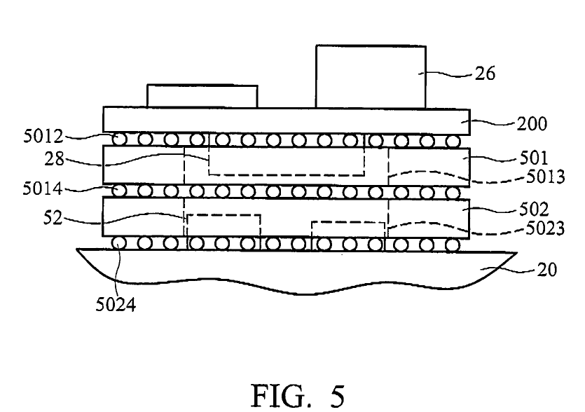

As shown in FIG. 5, a first adapter 501 and a second adapter 502 are disposed between the first circuit board 200 and the second circuit board 20. The electronic element 28 is accommodated in a first recess 5013 of the first adapter 501, and the electronic element 52 is accommodated in a second recess 5023 of the second adapter 502. BGA technology is applied in this embodiment. Therefore, a plurality of solder balls 5012 are disposed between the first circuit board 200 and the first adapter 501, and a plurality of solder balls 5014 are disposed between the first adapter 501 and the second adapter 502, and a plurality of solder balls 5024 are disposed between the second adapter 502 and the second circuit board 20. The solder balls 5012, 5014 and 5024 are heated and melted to complete the electrical connection of the first circuit board 200 and the second circuit board 20.

### Fifth Embodiment

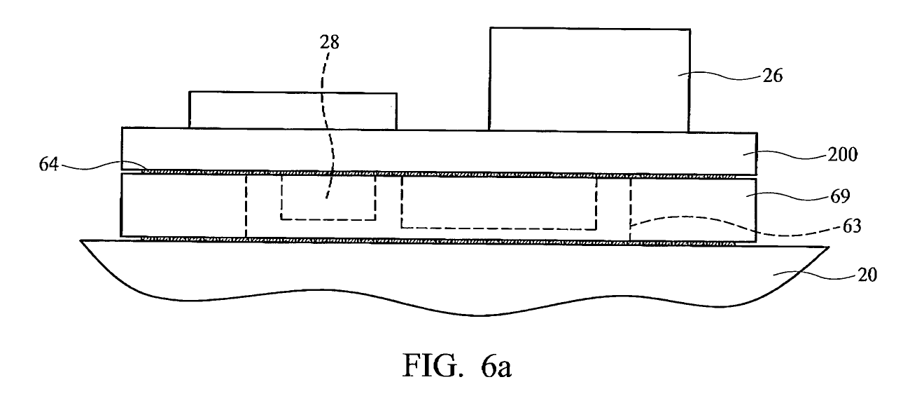

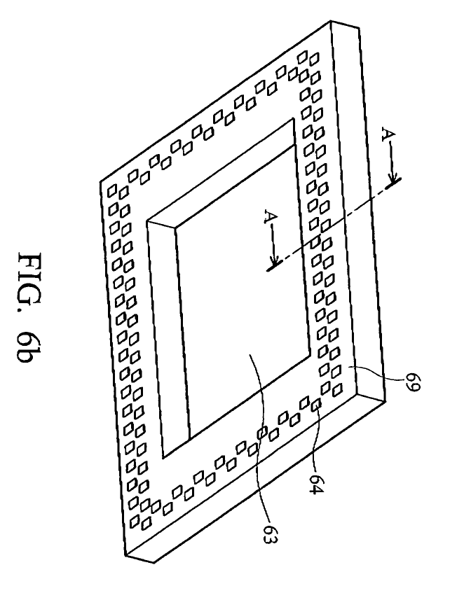

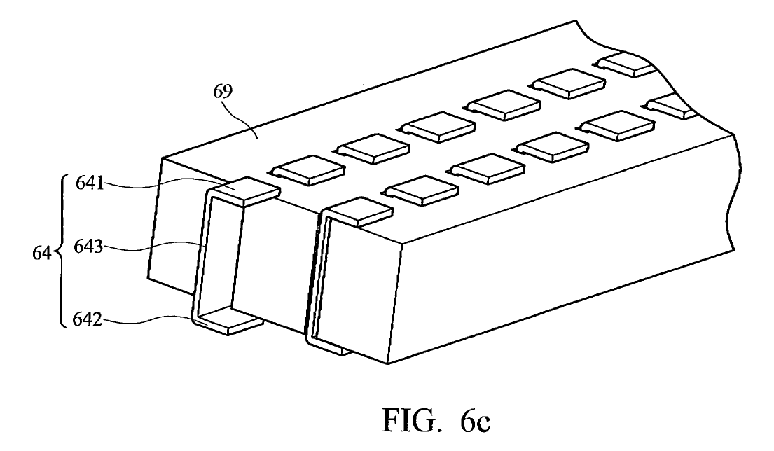

As shown in FIG. 6a, the first circuit board 200 bears the electronic element 26 on one side thereof and the electronic element 28 on the other side thereof. The first circuit board 200 is electrically connected to the second circuit board 20 via an adapter 69 having a recess 63 in which the electronic element 28 is accommodated.

FIG. 6b is a perspective view of the adapter 69 of the invention. FIG. 6c is cross section along line A-A in FIG. 6b. As shown in FIG. 6c, a plurality of connectors 64 are mounted on the adapter 69. The connector 64 is formed by inserting and bending copper sheet or column into the adapter 69 into a C shape. The connector 64 comprises a first contacting portion 641, a second contacting portion 642 and a connecting portion 643. The first contacting portion and the second contact portion are protruding over the adapter 69 to contact the first surface and the second surface respectively. The first contacting portion 641 contacts the first circuit board 200 and the second contacting portion 642 contacts the second circuit board 20. Solder is placed respectively between the first contacting portion 641 and the first circuit board 200 and between the second contacting portion 642 and the second circuit board 20. The solder is melted to complete the electrical connection of the first and second circuit boards 200 and 20.

As shown in FIGS. 6b and 6c, the connectors 64 are staggered around the recess 63. The arrangement of the connectors 64 and the copper trace on the first and second circuit boards 200 and 20 contribute to the shielding effect on the electronic element 28.

The adapter of the invention connects a circuit board having electronic elements on both sides thereof to another circuit board, which cannot be accomplished by the conventional art. Moreover, in the invention, BGA and LCC technology can be applied to the connection. The metal connectors of the invention further contribute to the shielding effect on the electronic elements accommodated in the recess.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic device, comprising:
a first circuit board;
a first electronic element disposed on the first circuit board;
a first adapter having a first surface, a second surface and a first recess; and
a second circuit board;
a wherein the first adapter is electrically connected to the first and second circuit boards and disposed therebetween, the first electronic element is accommodated in the first recess.

2. The electronic device as claimed in claim 1 further comprising a plurality of first solder balls disposed on the first surface the first circuit board and electrically connected to the first circuit board.

3. The electronic device as claimed in claim 2 further comprising a plurality of second solder balls disposed on the second surface and electrically connected to the second circuit board.

4. The electronic device as claimed in claim 1, wherein a plurality of first grooves are defined on the periphery of the first adapter and longitudinally extends perpendicular to the first and second circuit boards.

5. The electronic device as claimed in claim 4, wherein a plurality of metal pads corresponding to the first grooves are defined on the periphery of the first adapter.

6. The electronic device as claimed in claim 5, wherein a plurality of third grooves are defined on the periphery of the second circuit boards.

7. The electronic device as claimed in claim 1, wherein the first adapter further has a plurality of connectors comprising a first contacting portion, a second contacting portion and a connecting portion.

8. The electronic device as claimed in claim 7, wherein the connecting portion is embedded in the first adapter and the first contacting portion and the second contact portion are protruding over the first adapter to contact the first surface and the second surface respectively.

9. The electronic device as claimed in claim 8, wherein the first contacting portion, the second contacting portion and the connecting portion are integrally formed.

10. The electronic device as claimed in claim 8, wherein the first contacting portion contacts the first circuit board and the second contacting portion contacts the second circuit board.

11. The electronic device as claimed in claim 7, wherein the connectors are arranged around the first recess.

12. The electronic device as claimed in claim 11, wherein the connectors are arranged staggered.

13. The electronic device as claimed in claim 7, wherein the connectors are made of metal.

14. The electronic device as claimed in claim 1 further comprising:
a second electronic element disposed on the second circuit board; and
a second adapter having a second recess;
wherein the second adapter is disposed between the first adapter and the second circuit board, and the second electronic element is accommodated in the second recess.

15. A connection method, comprising:
providing an adapter having a recess and a plurality of connection points;
placing the adapter on a second circuit board to make the connection points electrically connect to a second circuit board; and
placing a first circuit board on the adapter so that an electronic element thereon is accommodated in the recess to make the connection points electrically connect to the first circuit board.
